(19) United States
(12) Patent Application Publication
(10) Pub. No.: US 2012/0314969 A1
(43) Pub. Date: Dec. 13, 2012

(54) IMAGE PROCESSING APPARATUS AND DISPLAY DEVICE INCLUDING THE SAME, AND IMAGE PROCESSING METHOD

(75) Inventors: Hiroyuki Furukawa, Osaka-shi (JP); Kazuyoshi Yoshiyama, Osaka-shi (JP); Naoko Kondoh, Osaka-shi (JP); Shinji Nakagawa, Osaka-shi (JP)

(73) Assignee: Sharp Kabushiki Kaisha, Osaka (JP)

(21) Appl. No.: 13/581,097

(22) PCT Filed: Feb. 22, 2011
(86) PCT No.: PCT/JP2011/053856

§ 371 Date: Aug. 24, 2012

(30) Foreign Application Priority Data
Feb. 25, 2010 (JP) 2010-040892

(51) Int. Cl. G06K 9/40

(52) U.S. Cl. 382/263

(57) ABSTRACT

An image processing apparatus where noise in a dark region indicated by an input image signal may be reduced and perceived fineness of texture may be enhanced is provided. It includes: a high pass filter (11) that extracts a high frequency component from an input image signal; a sign determining unit (12) that determines the sign of the high frequency component; a brightness value calculator (14) that determines the brightness value of the input image signal; and a parameter determining unit (gain value determining unit) (13) that determines a parameter (for example, a gain) to be used in the image processing for the high frequency component processor based on the brightness value and the sign information. The parameter determining unit (13) determines the parameter such that the degree to which shoot in the high frequency component is reduced when the sign information indicates positive is larger than the degree to which shoot in the high frequency component is reduced when the sign information indicates negative if the brightness value of the input image signal is not greater than a predetermined value.

### REFERENCE TO RELATED APPLICATIONS

This application is a national stage application under 35 USC 371 of International Application No. PCT/JP2011/053856, filed Feb. 22, 2011, which claims priority from Japanese Patent Application No. 2010-040892, filed Feb. 25, 2010, the entire contents of which are incorporated herein by reference.

### FIELD OF THE INVENTION

The present invention relates to an image processing apparatus and an image processing method for reducing noise in a region with a lower brightness specified by an input image signal (dark region), and a display device including such an image processing apparatus.

### BACKGROUND OF THE INVENTION

In recent years, the resolution of displays has been constantly increased. Particularly, in liquid crystal displays and plasma displays serving as television sets, higher levels of perceived fineness and resolution are demanded, partly due to increased resolution of television broadcast signals. To improve perceived resolution, edge enhancement of display images and enhancement of high frequency components are known.

However, edge enhancement of display images or enhancement of high frequency components by image processing cause noise to be enhanced in a region with a low brightness specified by an input signal (i.e. a dark region). Humans tend to visually perceive minor changes in brightness and color (i.e. noise) particularly in a dark region. Thus, noise in a dark region causes a decrease in display quality. Conventional approaches to this problem include image processing such as suppressing high frequency signals in a dark region based on a non-linear table in advance, increasing a threshold for coring (which means a process of attenuating high frequency signals) in a dark region, or reducing gain in high frequency amplification (see, for example, JP-Hei 6 (1994)-337933 A, JP-Hei 2 (1990)-121575 A and JP 2009-21905 A).

### SUMMARY OF THE INVENTION

While such conventional processes reduce increase in perceived noise in a dark region, they reduce enhancement of texture present in a dark region compared with a region with a high brightness (i.e. bright region). Thus, improvements in perceived resolution and fineness are not well perceivable in an image that is dark as a whole.

An object of the present invention is to provide an image processing apparatus and image processing method where noise in a dark region indicated by an input image signal may be reduced and perceived fineness of texture may be enhanced, and a display device including such an image processing apparatus.

To achieve the above object, an image processing apparatus disclosed herein includes: a high pass filter that extracts a high frequency component from an input image signal; a sign determining unit that determines a sign of the high frequency component output from the high pass filter to output sign information; a brightness value calculator that calculates a brightness value of the input image signal; a high frequency component processor that performs predetermined image processing on the high frequency component; a parameter determining unit that determines a parameter to be used in the image processing by the high frequency component processor based on the brightness value and the sign information; and an adder that adds an output of the high frequency component processor to the input image signal. The parameter determining unit determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

A display device disclosed herein includes the above described image processing apparatus and a display unit that performs display based on an output signal from the image processing apparatus.

Further, an image processing method disclosed herein includes: a high frequency component extraction process that extracts a high frequency component from an input image signal; a sign determination process that determines a sign of the high frequency component to output sign information; a brightness value calculation process that calculates a brightness value of the input image signal; predetermined image processing for the high frequency component; a parameter determination process that determines a parameter to be used in the image processing based on the brightness value and the sign information; and a process that adds an output of the image processing to the input image signal, wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

According to the present invention, an image processing apparatus and image processing method where noise in a dark region indicated by an input image signal may be reduced and perceived fineness of texture may be enhanced, and a display device including such an image processing apparatus may be provided.

### BRIEF DESCRIPTION OF THE DRAWINGS

FIG. 1 is a block diagram of an image processing apparatus according to a first embodiment.

FIG. 2 is a graph illustrating the relationship between brightness values provided by the brightness level calculator and gain values output from the gain value determining unit.

FIG. 3A is an illustration of examples of input image signals (original signals) to the image processing apparatus.

FIG. 3B is an illustration of examples of output signals from the image processing apparatus in response to the input image signals of FIG. 3A.

FIG. 4 is a block diagram of an image processing apparatus according to a second embodiment.

FIG. 5 is a graph illustrating an example of a relationship between the high frequency component input to the coring unit and the high frequency component output from the coring unit in the image processing apparatus according to the second embodiment.

FIG. 6 is a graph illustrating another example of a relationship between a high frequency component input to the coring unit and the high frequency component output from the coring unit in the image processing apparatus according to the second embodiment.

FIG. 7 is a block diagram of an image processing apparatus according to a third embodiment.

FIG. 8 is a schematic block diagram of a display device according to an embodiment of the present invention.

### DETAILED DESCRIPTION OF THE INVENTION

An image processing apparatus according to an embodiment of the present invention includes: a high pass filter that extracts a high frequency component from an input image signal; a sign determining unit that determines a sign of the high frequency component output from the high pass filter to output sign information; a brightness value calculator that calculates a brightness value of the input image signal; a high frequency component processor that performs predetermined image processing on the high frequency component; a parameter determining unit that determines a parameter to be used in the image processing by the high frequency component processor based on the brightness value and the sign information; and an adder that adds an output of the high frequency component processor to the input image signal, wherein the parameter determining unit determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

The image processing apparatus with the above configuration determines parameters such that the degree to which shoot in a high frequency component is reduced as a result of image processing by the high frequency component processor varies depending on whether the sign information indicates positive or negative if the brightness value of an input image signal is not greater than a predetermined value, i.e. if the input image signal indicates a location in a dark region. That is, the parameter determining unit determines parameters such that the degree to which shoot in the high frequency component is reduced when the sign information indicates positive is larger than the degree to which such shoot is reduced when the sign information indicates negative.

In this way, the image processing apparatus according to the present embodiment is capable of reducing amplification of perceived noise that accompanies an increased resolution in a dark region while enhancing perceived fineness of texture or the like. The reasons are as follows. Noise in a dark region is present as a small bright region on a dark background and is easy to be perceived by the human eye. If the sign information indicates positive, i.e. if the brightness value of an input image signal generally increases in the input time-series, reducing shoot in a direction with increasing brightness (overshoot) will reduce enhancement of perceived noise in a dark region. In this case, overshoot in texture that is present in the dark region will also be reduced; however, effects of shoot in a direction with decreasing brightness (undershoot) will provide enhancement in texture (enhancement of perceived fineness). Thus, it is possible to reduce amplification of perceived noise while enhancing perceived fineness of texture or the like.

In an embodiment of the above image processing apparatus, the high frequency component processor includes a multiplier that amplifies the high frequency component, the parameter determining unit includes a gain value determining unit that determines a gain for the multiplier based on the brightness value and the sign information, and the gain value determining unit determines, as a gain used when the sign information indicates positive, a value smaller than a gain used when the sign information indicates negative if the brightness value of the input image signal is not greater than a predetermined value.

According to this arrangement, the gain for a high frequency component in a dark region (amplification rate) varies depending on whether the sign information indicates positive or negative to reduce overshoot produced when the sign information indicates positive while maintaining undershoot produced when it indicates negative. Thus, it is possible to reduce amplification of perceived noise while enhancing perceived fineness of texture or the like.

In this arrangement, the gain value determining unit may determine, as the gain, a value that varies linearly depending on the brightness value if the brightness value is not greater than the predetermined value. Alternatively, the gain value determining unit may determine, as the gain, a value that varies non-linearly depending on the brightness value if the brightness value is not greater than the predetermined value.

In the above arrangement, the gain value determining unit may determine a fixed value of gain used when the sign information indicates positive and a fixed value of gain used when the sign information indicates negative, regardless of a magnitude of the brightness value, if the brightness value is not greater than the predetermined value. Alternatively, the gain value determining unit may determine a fixed value of gain regardless of whether the sign information indicates positive or negative if the brightness value is not smaller than the predetermined value. Still alternatively, the gain value determining unit may determine different values of gain depending on whether the sign information indicates positive or negative if the brightness value is not smaller than the predetermined value.

In another embodiment of the image processing apparatus with the above configuration, the high frequency component processor includes a coring unit that attenuates an amplification component of the high frequency component that is not greater than a threshold, the parameter determining unit includes a coring threshold determining unit that determines the threshold for the coring unit based on the brightness value and the sign information, and the coring threshold determining unit determines, as the threshold used when the sign information indicates positive, a value greater than the threshold used when the sign information indicates negative if the brightness value of the input image signal is not greater than a predetermined value.

In this arrangement, the threshold for coring used when the sign information indicates positive is set to a value greater than the threshold used when it indicates negative. Thus, the degree to which noise is reduced for a location in a dark region that has changes in brightness toward greater brightness (i.e. the sign information indicates positive) is larger than the degree to which noise is reduced for a location with changes in brightness toward smaller brightness (i.e. the sign information indicates negative). As a result, it is possible to make noise in a dark region less noticeable while maintaining enhancement of texture in the dark region.

In the above arrangement, the coring threshold determining unit may determine a fixed value as the threshold, regardless of whether the sign information indicates positive or negative, if the brightness value is not smaller than the predetermined value. Alternatively, the coring threshold determining unit may determine different values as the threshold depending on whether the sign information indicates positive or negative if the brightness value is not smaller than the predetermined value.

A display device according to an embodiment of the present invention includes: the image processing apparatus in any one of the above arrangements; and a display unit that performs display based on an output signal from the image processing apparatus. In this display device, a signal with reduced amplification of perceived noise and enhanced perceived fineness of texture or the like is supplied from the image processing apparatus, thereby achieving display with high quality.

The present invention may be carried out as a computer program that causes a computer to execute: a high frequency component extraction process that extracts a high frequency component from an input image signal; a sign determination process that determines a sign of the high frequency component to output sign information; a brightness value calculation process that calculates a brightness value of the input image signal; predetermined image processing for the high frequency component; a parameter determination process that determines a parameter to be used in the image processing based on the brightness value and the sign information; and a process that adds an output of the image processing to the input image signal, wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

Furthermore, a computer readable storage medium storing this computer program is also encompassed by an embodiment of the present invention.

Moreover, an image processing method according to an embodiment of the present invention includes: a high frequency component extraction process that extracts a high frequency component from an input image signal; a sign determination process that determines a sign of the high frequency component to output sign information; a brightness value calculation process that calculates a brightness value of the input image signal; predetermined image processing for the high frequency component; a parameter determination process that determines a parameter to be used in the image processing based on the brightness value and the sign information; and a process that adds an output of the image processing to the input image signal, wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

Embodiments of the present invention will now be described in detail with reference to the drawings, in which the same or corresponding elements are labeled with the same reference characters, and their description will not be repeated.

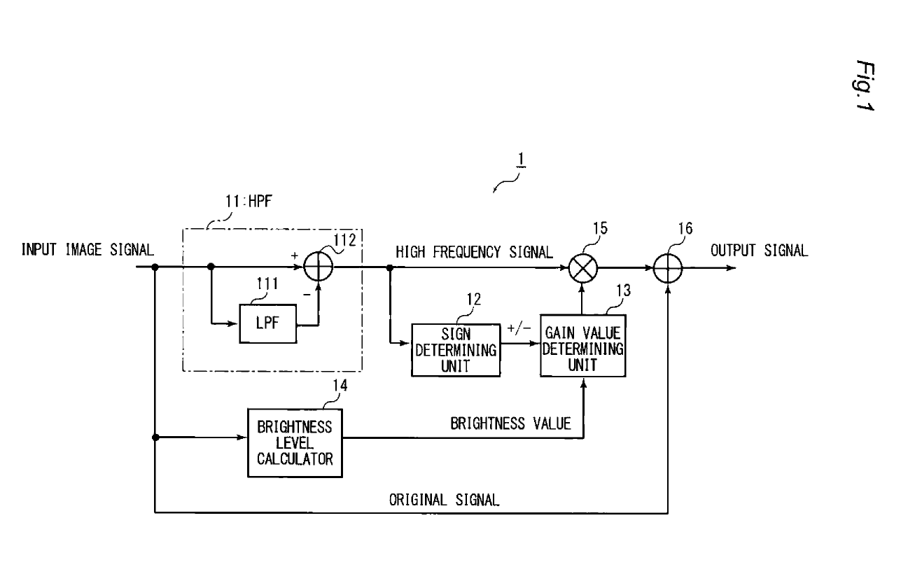

FIG. 1 is a block diagram of an image processing apparatus 1 according to a first embodiment. As shown in FIG. 1, the image processing apparatus 1 includes a high pass filter (HPF) 11, sign determining unit 12, gain value determining unit 13, brightness level calculator 14, multiplier 15 and adder 16.

The high pass filter 11 takes only high frequency components out of an input image signal and outputs them to the sign determining unit 12 and multiplier 15. The input image signal includes signal values for pixels of different colors, i.e. R (red), G (green) and B (blue), for example. The high pass filter 11 includes a low pass filter (LPF) 111 and subtracter 112. The low pass filter 111 takes only low frequency components out of the input image signal and outputs them to the subtracter 112. The subtracter 112 subtracts the output from the low pass filter 111 from the input image signal. This results in an output of the high pass filter 11 including only the high frequency components taken out of the input image signal.

The high frequency components output from the high pass filter 11 do not include direct current components. As such, the output from the high pass filter 11 has a positive or negative sign. That is, the output from the high pass filter 11 indicates degrees of change in the input image signal. If the sign of the output from the high pass filter 11 is positive, it means that the spatial frequency in the input image signal increases within the screen, and a negative sign means that the spatial frequency of the input image signal decreases within the screen. The sign determining unit 12 determines whether the high frequency signal output from the high pass filter 11 is positive or negative and outputs the result as sign information to the gain value determining unit 13.

The brightness level calculator 14 determines a brightness value by performing matrix operations or the like on the input image signal. To calculate a brightness value, it is desirable that a filter be used to prevent changes in gain value from being extreme. Specifically, if the brightness value of the input image signal is calculated on a pixel basis, the changes in brightness specified by the input image signal directly affect the output image. This may cause the degree of amplification of the high frequency signal to fluctuate locally, causing the output image to appear unnatural. To minimize such changes, the brightness level calculator 14 preferably calculates a brightness value of a pixel in interest, which is to be used to calculate a brightness level, while taking into consideration the brightness values of nearby pixels in the horizontal and/or vertical directions.

The gain value determining unit 13 determines a gain value based on the sign information from the sign determining unit 12 and the brightness value of the input image signal calculated by the brightness level calculator 14. A method of determining a gain value with the gain value determining unit 13 will be described in detail below.

The multiplier 15 enhances the high frequency signal by multiplying the high frequency signal by the gain value calculated by the gain determining unit 13. Finally, the adder 16 adds the enhanced high frequency signal to the input image signal to provide an output signal.

If the input image signal is not monochromatic, it is preferable that a high frequency signal of each color is enhanced separately. For example, if the input image signal includes the three colors R, G and B, it is preferable that three such circuit arrangements as shown in FIG. 1 are provided for the image signals of R, G and B. Further, it is desirable that one gain value determining unit 13 be common to the image signals of R, G and B.

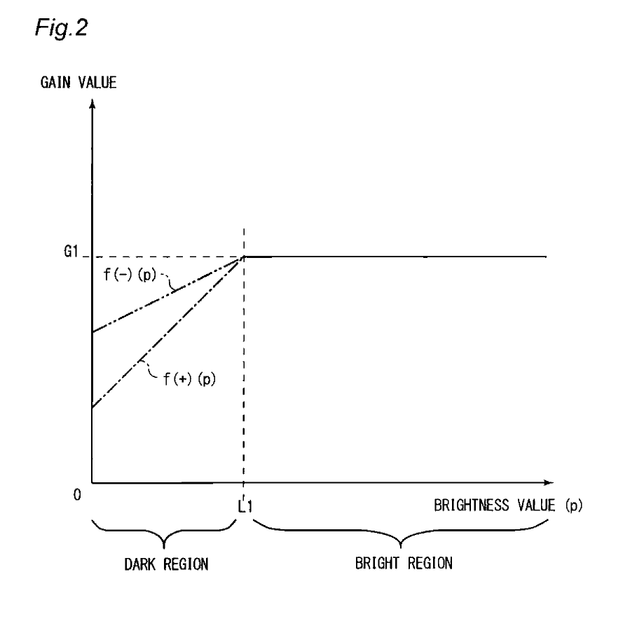

Now, the relationship between the sign information and brightness value input to the gain value determining unit 13 and the gain value output from the gain value determining unit 13 will be described with reference to FIG. 2.

In the graph shown in FIG. 2, the horizontal axis represents the brightness value provided by the brightness level calculator 14, while the vertical axis represents the gain value output from the gain value determining unit 13. As shown in FIG. 2, if the input brightness value is not smaller than the predetermined value L1, the gain value determining unit 13 outputs a constant gain value, G1, independent of the magnitude of the brightness value. If the input brightness value is smaller than the predetermined value L1, the gain value determining unit 13 determines a gain value based on the characteristic function f(+)(p) if the sign information from the sign determining unit 12 indicates positive. Here, “p” denotes the brightness value. On the other hand, the gain value determining unit 13 determines a gain value based on the characteristic function f(−)(p) if the sign information from the sign determining unit 12 indicates negative.

That is, if the input brightness value is smaller than the predetermined value L1, it is determined that the pixel having this brightness value is in a dark region, and gain values are determined such that the gain value used when the sign information indicates positive is smaller than the gain value used when the sign information indicates negative.

The predetermined value L1 indicates a threshold between a region that should be treated as a bright region and a region that should be treated as a dark region, and can be determined as appropriate depending on the properties of the image display device, the desired image quality and the like. Similarly, the gain value G1 for a bright region as well as the slopes of the characteristic functions f(+)(p) and f(−)(p) for determining a gain value for a dark region may be determined as appropriate depending on the properties of the image display device, the desired image quality and the like.

In the example of FIG. 2, both of the characteristic functions f(+)(p) and f(−)(p) are linear (direct functions). However, the characteristic functions f(+)(p) and f(−)(p) may be non-linear functions as long as f(+)(p)≦f(−)(p) for all values of p where 0≦p<L1.

An actual example of a configuration of the gain value determining unit 13 may include two lookup tables provided in the gain value determining unit 13. In this case, one lookup table (positive sign table) is referred to if the sign information from the sign determining unit 12 indicates positive (+), while the other lookup table (negative sign table) is referred to if the sign information from the sign determining unit 12 indicates negative (−). An identical gain value (G1 of FIG. 2) for brightness values p that are not smaller than the predetermined value L1 is stored in both lookup tables. Discrete values of the characteristic function f(+)(p) are stored in the positive sign table as gain values for a plurality of brightness values p that are smaller than the predetermined value L1. Discrete values of the characteristic function f(−)(p) are stored in the negative sign table as gain values for a plurality of brightness values p that are smaller than the predetermined value L1.

To minimize the number of elements of the lookup tables, it is also preferable that, if the gain value corresponding to an input brightness value is not stored in a lookup table, the gain value corresponding to this input brightness value is calculated by interpolating the gain values stored in the lookup table corresponding to brightness values preceding and following the input brightness value.

In the above example, a constant gain value (G1 of FIG. 2) for brightness values p that are not smaller than the predetermined value L1 is stored in each of the positive sign table and the negative sign table. However, the gain value for brightness values p that are not smaller than the predetermined value L1 need not be constant and may be varied depending on the brightness value p. Further, different gain values may be provided for the positive sign table and negative sign table for brightness values p that are not smaller than the predetermined value L1.

The configuration of the gain value determining unit 13 is not limited to the above arrangement using lookup tables. For example, the following arrangements are possible to simplify the gain value determining unit 13: three gain values, i.e. a low-brightness positive-sign gain value g1, a low-brightness negative-sign gain value g2 and a middle/high-brightness gain value g3 are stored in the memory in the gain value determining unit 13 in advance, where g1<g2≦g3. If the brightness value is not smaller than the predetermined value L1, the gain value determining unit 13 outputs the middle/high-brightness gain value g3 regardless of the sign information. If the brightness value is smaller than the predetermined value L1, the gain value determining unit 13 outputs the low-brightness positive-sign gain value g1 if the sign information indicates positive, and the low-brightness negative-sign gain value g2 if the sign information indicates negative.

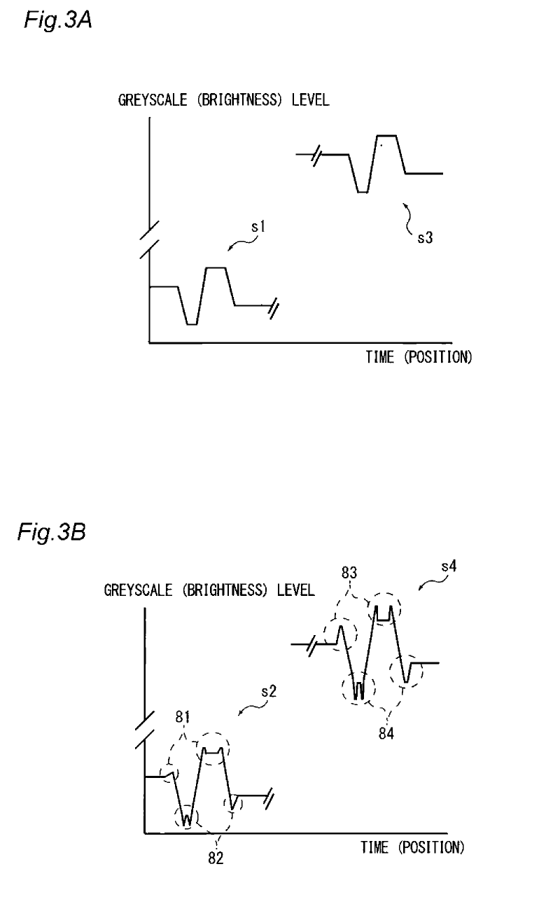

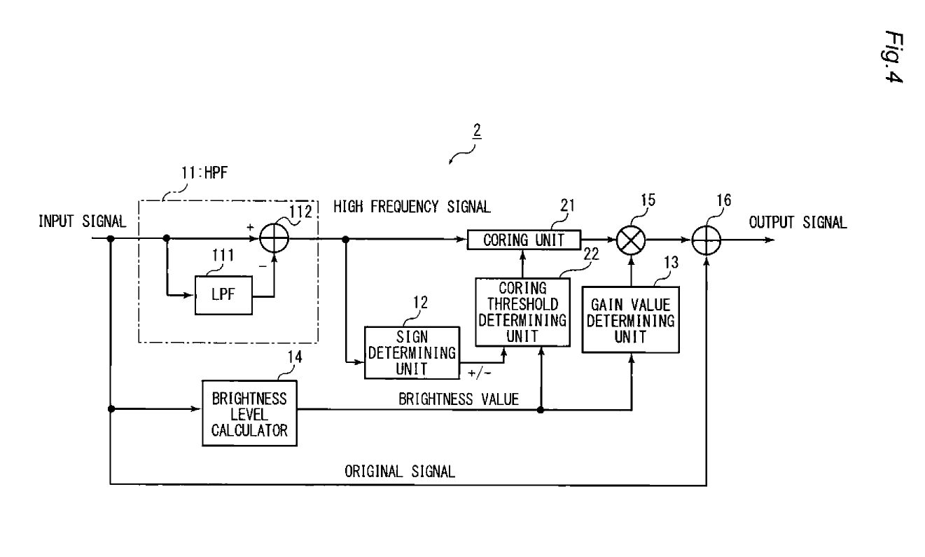

Referring to FIGS. 3A and 3B, effects of image processing by the image processing apparatus 1 will be described. FIG. 3A shows examples of input image signals (original signals) to the image processing apparatus 1, while FIG. 3B shows examples of output signals of the image processing apparatus 1 in response to the input image signals of FIG. 3A.

Amplifying a high frequency signal when the sign information indicates positive adds so called overshoot to the image. On the other hand, amplifying a high frequency signal when the sign information indicates negative results in an image with undershoot added to it. If the gain added to the input image signal s1 in a dark region shown in FIG. 3A when the sign information indicates positive is smaller than the gain added when the sign information indicates negative, overshoot 81 is reduced in the output signal s2 derived from the input image signal s1 while sufficient undershoot 82 is added, as shown in FIG. 3B.

Noise in a dark region is present as a small bright region on a dark background and is easy to be perceived by the human eye. Since overshoot is a type of enhancement that increases brightness, reducing overshoot in a dark region will reduce enhancement of perceived noise. In this case, overshoot in texture present in the dark region will be reduced at the same time; however, the effects of undershoot provide enhancement of texture (i.e. enhancement of perceived fineness). Thus, it is possible to reduce amplification of perceived noise that accompanies increased resolution in a dark region while enhancing perceived fineness of texture or the like.

Regarding the input image signal s3 for a bright region shown in FIG. 3A, the high frequency components are amplified by a gain that is not smaller than that for an input image signal for a dark region regardless of whether the sign information provided by the sign determining unit 12 indicates positive or negative, and thus the output signal s4 for a bright region derived from the input image signal s3 has relatively large shoot 83 and 84, as shown in FIG. 3B, providing sufficient enhancement of perceived fineness.

In this way, if the sign information provided by the sign determining unit 12 indicates positive, the image processing apparatus 1 of the present embodiment amplifies a high frequency component of an input image signal for a dark region by a gain smaller than that used if the sign information indicates negative. Thus, it is possible to reduce amplification of perceived noise in a dark region while enhancing perceived fineness of texture or the like in this dark region.

A second embodiment of the present invention will be described below.

FIG. 4 is a block diagram of an image processing apparatus according to a second embodiment. As shown in FIG. 4, the image processing apparatus 2 according to the second embodiment is the image processing apparatus 1 according to the first embodiment plus a coring unit 21 and a coring threshold determining unit 22.

The coring unit 21 blocks small high frequency signals with an amplification not greater than a coring threshold determined by the coring threshold determining unit 22. Thus, it is possible to remove small noise or the like while maintaining clear edges of an input image signal. The coring threshold determining unit 22 determines a coring threshold based on sign information provided by the sign determining unit 12 and a brightness value provided by the brightness level calculator 14.

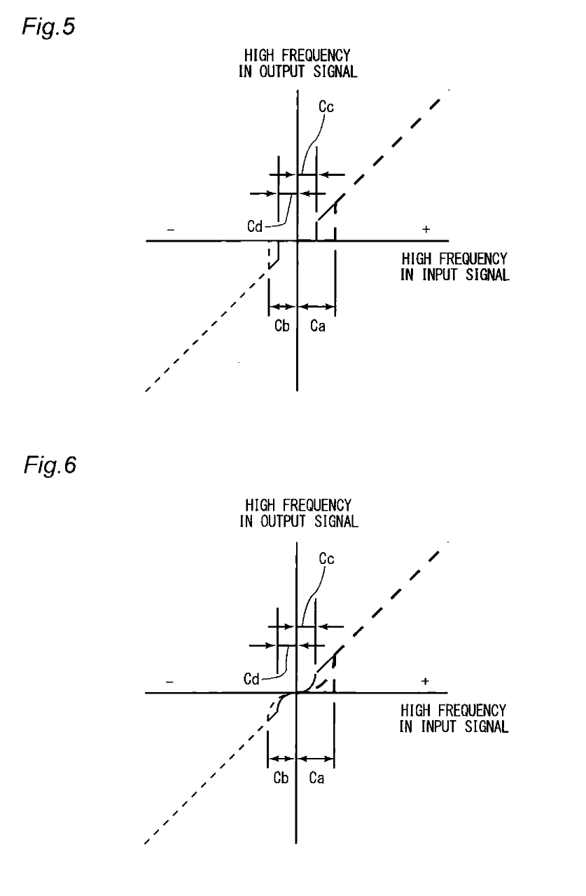

FIG. 5 is a graph illustrating the relationship between the high frequency component input to the coring unit 21 and the high frequency component output from the coring unit 21. In FIG. 5, Ca, Cb, Cc and Cd are coring thresholds provided by the coring threshold determining unit 22. The coring threshold Ca is used when the brightness information indicates a level not greater than the predetermined value L1 and the sign information indicates positive. The coring threshold Cb is used when the brightness information indicates a level not greater than the predetermined value L1 and the sign information indicates negative. The coring threshold Cc is used when the brightness information indicates a level not smaller than the predetermined value L1 and the sign information indicates positive. The coring threshold Cd is used when the brightness information indicates a level not smaller than the predetermined value L1 and the sign information indicates negative.

The coring threshold determining unit 22 determines coring thresholds such that the coring thresholds Ca, Cb, Cc and Cd satisfy the following Equation 1.

Cd≦Cc≦Cb<Ca (Equation 1)

In the example shown in FIG. 5, the relationship among the coring thresholds Ca, Cb, Cc and Cd is expressed by the following Equation 2.

Cd=Cc<Cb<Ca (Equation 2)

However, the relationship shown in FIG. 5 is merely an example, and Cd<Cc or Cc=Cb may be used, as shown in Equation 1.

In the example shown in FIG. 5, if the brightness information indicates a level not greater than the predetermined value L1 and the sign information indicates positive, the coring threshold Ca is provided by the coring threshold determining unit 22 to the coring unit 21. Thus, out of the high frequency components input to the coring unit 21, the components with an amplification not greater than the coring threshold Ca are blocked (see the long-dashed line in FIG. 5).

If the brightness information indicates a level not greater than the predetermined value L1 and the sign information indicates negative, the coring threshold Cb is provided by the coring threshold determining unit 22 to the coring unit 21. Thus, out of the high frequency components input to the coring unit 21, the components with an amplification not greater than the coring threshold Cb are blocked (see the short-dashed line in FIG. 5).

If the brightness information indicates a level not smaller than the predetermined value L1 and the sign information indicates positive, the coring threshold Cc is provided by the coring threshold determining unit 22 to the coring unit 21. Thus, out of the high frequency components input to the coring unit 21, the components with an amplification not greater than the coring threshold Cc are blocked (see the solid line in FIG. 5).

If the brightness information indicates a level not smaller than the predetermined value L1 and the sign information indicates negative, the coring threshold Cd is provided by the coring threshold determining unit 22 to the coring unit 21. Thus, out of the high frequency components input to the coring unit 21, the components with an amplification not greater than the coring threshold Cd are blocked (see the solid line in FIG. 5).

Setting such coring thresholds will result in the following advantages: The coring threshold is set to Ca when the brightness of an input image signal is not greater than a predetermined value and changes in the positive direction. In this case, the coring threshold is set to Ca to block high frequency components from the high pass filter.

The coring threshold is set to Cb when the brightness of an input image signal is not greater than a predetermined value and changes in the negative direction. In this case, the coring threshold is set to Cb to block high frequency components from the high pass filter.

The coring threshold Ca being set to a value that is greater than Cb will result in the following advantages in particular: The degree to which noise is reduced for a location in a dark region that has a change in brightness toward greater brightness (the sign information indicates positive) is larger than the degree to which noise is reduced for a location with a change in brightness toward smaller brightness (the sign information indicates negative). As a result, it is possible to make noise in a dark region less noticeable while maintaining enhancement of texture in the dark region.

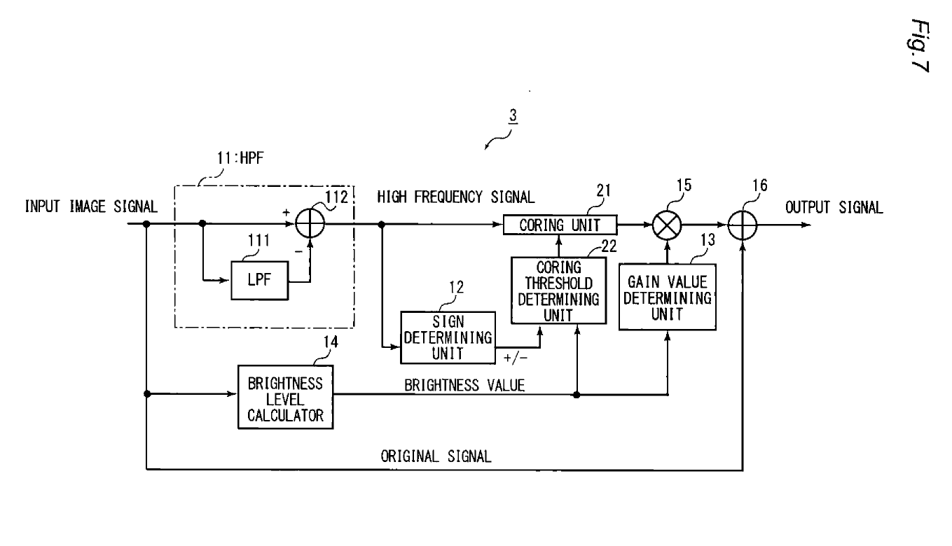

FIG. 5 shows an implementation where the components with an amplification that is smaller than a coring threshold are completely blocked by the coring unit 21 (100% attenuation); however, the attenuation rate may be smaller than 100%, as shown in FIG. 6, for example.

In the image processing apparatus 2 of the present embodiment, the high frequency signal output from the coring unit 21 is multiplied by the multiplier 15 by a gain value determined by the gain value determining unit 13 in a manner similar to the first embodiment, and is added to the original signal by the adder 16.

In this process, the image processing apparatus 2 is capable of reducing amplification of perceived noise in a dark region while enhancing perceived fineness of texture or the like in this dark region.

A third embodiment of the present invention will be described below.

FIG. 7 is a block diagram of an image processing apparatus 3 according to a third embodiment. As shown in FIG. 7, the image processing apparatus 3 includes, instead of the gain value determining unit 13, a gain value determining unit 33 that determines a gain value only based on a brightness value regardless of sign information from the sign determining unit 12. The coring unit 21 and coring threshold determining unit 22 of the image processing apparatus 3 operate in a manner similar to those of the second embodiment.

Thus, the image processing apparatus 3 is also capable of reducing amplification of perceived noise in a dark region while enhancing perceived fineness of texture or the like in this dark region by determining a coring threshold based on sign information from the sign determining unit 12 and a brightness value from the brightness level calculator 14 such that Equation 1, described in connection with the second embodiment, is satisfied.

FIG. 7 shows an implementation where the gain value determining unit 33 determines a gain value depending on a brightness value. However, the gain value determining unit 33 may provide a constant amount of gain to the multiplier 15 regardless of the magnitude of the brightness value. In this case, the signal line from the brightness level calculator 14 to the gain value determining unit 33 shown in FIG. 7 is not necessary.

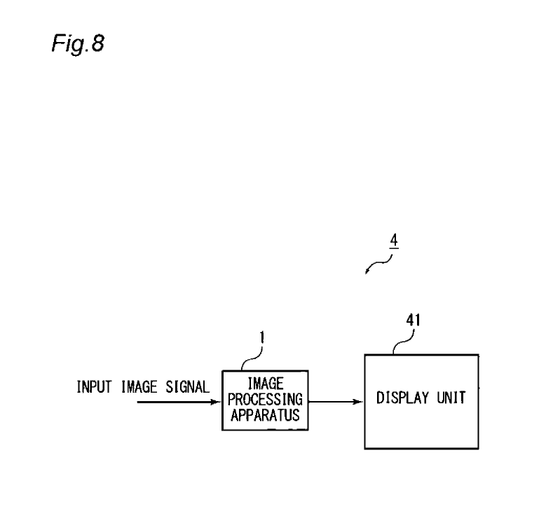

FIG. 8 is a schematic block diagram of a display device according to an embodiment of the present invention. As shown in FIG. 8, a display device 4 according to the present embodiment includes a display unit 41 that displays an image based on an input image signal. The display unit 41 is not limited to a particular display. For example, the display unit 41 may be any display such as a liquid crystal display or plasma display.

The display device 4 further includes the image processing apparatus 1 according to the first embodiment upstream from the input terminal of the display unit 41. Thus, the display unit 41 is supplied with a signal with reduced amplification of perceived noise in a dark region and enhanced perceived fineness of texture or the like in this dark region, thereby achieving high quality display.

In the display device 4, the image processing apparatus 1 may be implemented as a circuit chip mounted on a circuit board, for example. Alternatively, the image processing apparatus 1 may be implemented as a memory device storing a computer program that implements the functions of the image processing apparatus and a general purpose processor that reads a program from the memory device and executes it.

FIG. 8 illustrates a display device including the image processing apparatus 1 according to the first embodiment. However, the image processing apparatus 1 may be replaced by the image processing apparatus 2 according to the second embodiment or the image processing apparatus 3 according to the third embodiment.

Although embodiments of the present invention have been described, the above embodiments are examples used for carrying out the invention only. As such, the present invention is not limited to the above embodiments, and the above embodiments may be modified as appropriate without departing from the spirit of the invention.

The present invention can be industrially used as an image processing apparatus for input image signals and a display device including such an image processing apparatus.

1. An image processing apparatus comprising:
a high pass filter that extracts a high frequency component from an input image signal;
a sign determining unit that determines a sign of the high frequency component output from the high pass filter to output sign information;
a brightness value calculator that calculates a brightness value of the input image signal;
a high frequency component processor that performs predetermined image processing on the high frequency component;
a parameter determining unit that determines a parameter to be used in the image processing by the high frequency component processor based on the brightness value and the sign information; and
an adder that adds an output of the high frequency component processor to the input image signal,
wherein the parameter determining unit determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

2. The image processing apparatus according to claim 1, wherein:
the high frequency component processor includes a multiplier that amplifies the high frequency component,
the parameter determining unit includes a gain value determining unit that determines a gain for the multiplier based on the brightness value and the sign information, and
the gain value determining unit determines, as a gain used when the sign information indicates positive, a value smaller than a gain used when the sign information indicates negative if the brightness value of the input image signal is not greater than a predetermined value.

3. The image processing apparatus according to claim 2, wherein:
the gain value determining unit determines, as the gain, a value that varies linearly depending on the brightness value if the brightness value is not greater than the predetermined value.

4. The image processing apparatus according to claim 2, wherein:
the gain value determining unit determines, as the gain, a value that varies non-linearly depending on the brightness value if the brightness value is not greater than the predetermined value.

5. The image processing apparatus according to claim 2, wherein:
the gain value determining unit determines a fixed value of gain used when the sign information indicates positive and a fixed value of gain used when the sign information indicates negative, regardless of a magnitude of the brightness value, if the brightness value is not greater than the predetermined value.

6. The image processing apparatus according to claim 2, wherein:
the gain value determining unit determines a fixed value of gain regardless of whether the sign information indicates positive or negative if the brightness value is not smaller than the predetermined value.

7. The image processing apparatus according to claim 2, wherein:
the gain value determining unit determines different values of gain depending on whether the sign information indicates positive or negative if the brightness value is not smaller than the predetermined value.

8. The image processing apparatus according to claim 1, wherein:
the high frequency component processor includes a coring unit that attenuates an amplification component of the high frequency component that is not greater than a threshold,
the parameter determining unit includes a coring threshold determining unit that determines the threshold for the coring unit based on the brightness value and the sign information, and
the coring threshold determining unit determines, as the threshold used when the sign information indicates positive, a value greater than the threshold used when the sign information indicates negative if the brightness value of the input image signal is not greater than a predetermined value.

9. The image processing apparatus according to claim 8, wherein:
the coring threshold determining unit determines a fixed value as the threshold, regardless of whether the sign information indicates positive or negative, if the brightness value is not smaller than the predetermined value.

10. The image processing apparatus according to claim 8, wherein:
the coring threshold determining unit determines different values as the threshold depending on whether the sign information indicates positive or negative if the brightness value is not smaller than the predetermined value.

11. A display device comprising:
the image processing apparatus according to claim 1; and
a display unit that performs display based on an output signal from the image processing apparatus.

12. A computer executable program that causes a computer to execute:
a high frequency component extraction process that extracts a high frequency component from an input image signal;
a sign determination process that determines a sign of the high frequency component to output sign information;
a brightness value calculation process that calculates a brightness value of the input image signal;
predetermined image processing for the high frequency component;
a parameter determination process that determines a parameter to be used in the image processing based on the brightness value and the sign information; and
a process that adds an output of the image processing to the input image signal, wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

13. An image processing method comprising:
a high frequency component extraction process that extracts a high frequency component from an input image signal;
a sign determination process that determines a sign of the high frequency component to output sign information;
a brightness value calculation process that calculates a brightness value of the input image signal;
predetermined image processing for the high frequency component;
a parameter determination process that determines a parameter to be used in the image processing based on the brightness value and the sign information; and
a process that adds an output of the image processing to the input image signal,
wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.

14. A computer readable storage medium storing a computer executable program that causes a computer to execute:
a high frequency component extraction process that extracts a high frequency component from an input image signal;
a sign determination process that determines a sign of the high frequency component to output sign information;
a brightness value calculation process that calculates a brightness value of the input image signal;
predetermined image processing for the high frequency component;
a parameter determination process that determines a parameter to be used in the image processing based on the brightness value and the sign information; and
a process that adds an output of the image processing to the input image signal,
wherein the parameter determination process determines the parameter such that a degree to which shoot in the high frequency component is reduced when the sign information indicates positive is larger than a degree to which shoot in the high frequency component is reduced when the sign information indicates negative if the brightness value of the input image signal is not greater than a predetermined value.
